(19) United States
(12) Patent Application Publication
(10) Pub. No.: US 2023/0266968 A1
(43) Pub. Date: Aug. 24, 2023

(54) BROADCAST DATA, SHARED WEIGHT MULTIPLY-ACCUMULATE

(71) Applicant: Flex Logix Technologies, Inc., Mountain View, CA (US)

(72) Inventors: Frederick A. Ware, Los Altos Hills, CA (US); Cheng C. Wang, Los Altos, CA (US)

(21) Appl. No.: 18/111,846

(22) Filed: Feb. 20, 2023

Related U.S. Application Data
(60) Provisional application No. 63/312,141, filed on Feb. 21, 2022.

(51) Int. Cl. G06F 9/30; G06F 7/544; G06F 7/523

(52) U.S. Cl. CPC G06F 9/3001; G06F 7/5443; G06F 7/523

(57) ABSTRACT

An integrated circuit device includes broadcast data paths, a weighting-value memory, and multiply-accumulate (MAC) units. The MAC units are coupled in common to each of the broadcast data paths and coupled to receive respective weighting values from the weighting-value memory via respective weighting-value paths. Each of the MAC units includes a plurality of MAC circuits coupled respectively to the broadcast data paths, with each of the MAC circuits within a given one of the MAC units (i) receiving an input data value via a respective one of the broadcast data paths and a shared one of the weighting values via a shared one of the respective weighting-value paths, (ii) generating a sequence of multiplication products by multiplying the input data value with the shared one of the weighting values, and (iii) accumulating a sum of the multiplication products.

### CROSS REFERENCE TO RELATED APPLICATIONS

This application hereby incorporates by reference and claims the filing-date benefit of U.S. provisional application No. 63/312,141 filed Feb. 21, 2022.

### DRAWINGS

The various embodiments disclosed herein are illustrated by way of example, and not by way of limitation, in the figures of the accompanying drawings and in which like reference numerals refer to similar elements and in which:

FIG. 1 illustrates an embodiment of an integrated-circuit inferencing engine having hierarchically arranged broadcast-data TPUs (tensor processing units) together with supporting memory, interconnect circuitry and physical signaling interfaces;

FIG. 2 contrasts a multi-data tensor processing scheme with a broadcast-data tensor processing approach implemented within the TPUs of FIG. 1;

FIG. 3 illustrates an exemplary execution of the FIG. 2 broadcast data example within an exemplary set of four multiply-accumulate (MAC) processors, showing the cycle-by-cycle transition of the input data value and respective rows of the filter weight matrix applied within the MAC processors in each MAC operation;

FIG. 4 illustrates a more detailed embodiment of a broadcast-data TPU;

FIG. 5 illustrates an exemplary pipelined vector multiplication executed within the FIG. 4 broadcast-data TPU;

FIG. 6 presents an exemplary tensor processing operation executed via parallel component-tensor processing within the data-broadcasting TPUs of FIG. 1 in accordance with the FIG. 5 MAC pipeline;

FIG. 7 illustrates an exemplary vector-matrix multiply operation parallel-processed within an array of broadcast-data TPUs;

FIG. 8 illustrates an exemplary MAC pipeline timing diagram corresponding to the FIG. 5 MAC pipeline, showing a sequence of vector multiply and pipelined operations therein;

FIG. 9 illustrates an embodiment of a broadcast-data TPU having a register-segmented broadcast data line;

FIG. 10 illustrates an embodiment of a broadcast-data TPU having a multi-channel broadcast data store, multi-channel MAC engine and multi-channel data I/O structure that enables two or more independent or correlated streams of broadcast data values to be vector multiplied with a given filter weight matrix simultaneously to yield corresponding streams of output values;

FIG. 11 presents an exemplary tensor processing operation executed via parallel component-tensor processing within a single-weight, multiple broadcast data TPU implemented generally as shown FIG. 10;

FIGS. 12A, 12B and 12C illustrate contrasting embodiments of dual-channel MAC units that may be implemented (or programmably configured/enabled) within the various single-weight multiple broadcast data TPU embodiments discussed in reference to FIGS. 10 and 11;

FIG. 13 illustrates a more generalized channel combination circuit that may be implemented within a single-weight, multiple broadcast data TPU; and

FIG. 14 illustrates an embodiment of a single-weight, multiple broadcast data TPU having multiply-accumulate circuits disposed in a MAC circuit array.

### DETAILED DESCRIPTION

In various embodiments herein multiply-accumulate (MAC) processors within a tensor processing unit (TPU) simultaneously execute, in each of a sequence of MAC cycles, respective multiply operations using a shared (common) input data operand and respective weighting operands, each of the MAC processors applying a new shared input data operand and respective weighting operand in each successive MAC cycle to accumulate, as a component of an output tensor, a respective sum-of-multiplication-products. The shared-data TPU architecture—referred to herein as a broadcast-data architecture as each new input-data value is broadcast to data inputs of all constituent MAC processors of the TPU—provides a number of potential advantages relative to legacy multi-data architectures (i.e., in which each of N parallel MAC processors multiplies a respective one of N data values with a respective weighting operand during a given MAC cycle) including, for example and without limitation:
substantially reduced processing latency as shared input data may be loaded in parallel into all N MAC processors in a single clock cycle, avoiding the N clock-cycle load time required in multi-data architectures (e.g., shifting N data values into the N MAC processors over N successive clock cycles) and thus reducing end-to-end tensor processing latency by N−1 clock cycles;
obviated cycle-to-cycle data exchange between the MAC processors—no cycle-to-cycle shifting/rotating of different input data values between MAC processors (as required in a data-rotate multi-data TPU) or accumulated output data values between MAC processors (as required in an output-rotate multi-data TPU) and thus providing/enabling:
   improved timing margin (and therefore headroom for reduced MAC cycle time) relative to output-rotate architectures at least, by avoiding output rotation overhead within the summation/accumulation pipeline stage;
   input tensor depth (number of input data values, K, per input tensor or input sub-tensor) greater or less than per-TPU MAC processor count, N, as each MAC processor may execute an unlimited number (up to the point of numeric overflow) of multiply-accumulate operations to generate an output tensor result;
non-skewed (matrix-aligned) weighting operand storage within MAC processor memory, obviating circuitry generally required in multi-data TPU architectures to effect skewed storage of dynamically generated weight matrices.

In a number of embodiments, the decoupling of input tensor depth from TPU width (number of constituent MAC processors) enables more flexible mapping of input tensors to TPUs and/or simplified result aggregation/combination within sets of TPUs assigned to generate a given output tensor. In embodiments in which data propagation time over the broadcast data path (i.e., data path coupled to data inputs of respective MAC processors within a given TPU) exceeds the timing margin required for reliable capture within all MAC processors, the broadcast data path may be segmented by one or more pipe-stage registers, with upstream MAC processors including one or more additional input register stages to levelize the data input to the multiply stages within all MAC processors. In other embodiments, two or more broadcast data channels are supplied in parallel to the MAC processors within a given TPU, with each MAC processor including two or more multiply-accumulate units within each MAC processor (i.e., the per-processor MAC unit count corresponding to the number of parallel broadcast data channels). In such embodiments, a single, shared filter weight value may be multiplied with respective broadcast data values—one broadcast data value from each different data channel—within respective MAC units in each MAC cycle, thus effecting a single-weight, multi-broadcast data TPU architecture (SWMBD TPU) in which each MAC unit effectively implements a respective MAC channel. In a number of SWMBD embodiments, two or more broadcast data channels may convey constituent n-bit components of an N-bit value, where, for example, N=2n, 4n, 8n, etc. In those cases, referred to herein as single-weight, compound broadcast data (SWCBD), the MAC units (forming respective MAC channels) within a given processor may be inter-coupled to exchange partial multiplication results, carry data and so forth as necessary to effect significance-weighted multiply and accumulated operations (e.g., carry from multiply operation and summation operation in less-significant MAC channel to more significant MAC channel). In other compound broadcast data embodiments, the MAC channels independently generate values of different significance (no carry and/or partial results exchanged between MAC channels) with those values being combined in a final-accumulation stage, for example, within interface circuitry that links the TPU to other circuit blocks (including other TPUs) within the host integrated circuit device. These and other features and embodiments are discussed in further detail below.

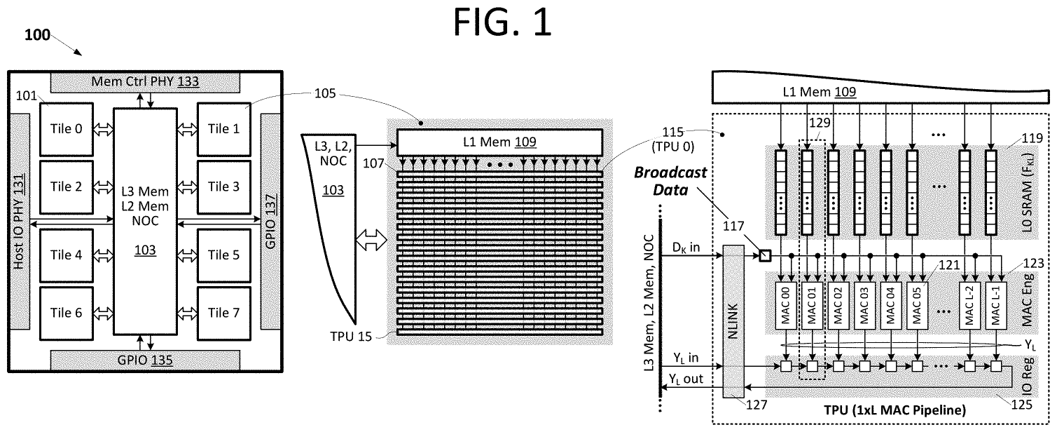

FIG. 1 illustrates an embodiment of an integrated-circuit inferencing engine 100 (“inferencing IC”) having broadcast-data TPUs grouped/clustered within processing tiles 101 and interconnected to one another, on-die memory and various physical signaling interfaces via a network-on-chip interconnect 103. In the depicted implementation, each of the processing tiles 101—shown for example in detail view 105—includes sixteen TPUs 107 (a x16 TPU cluster) coupled to receive filter weight values from a shared local (tile-resident) memory 109 referred to herein as level-one (L1) memory. Referring to the exemplary detail at 115, each TPU 107 includes a broadcast data register 117 and high-speed/low-latency filter-weight storage 119 (referred to herein as a level-zero (L0) memory), together with a bank of ‘L’ multiply-accumulate units 121 (collectively implementing a MAC engine 123), input/output (I/O) shift register 125, and linking logic 127 (“NLINK”), the latter for interfacing to the broadcast data register and I/O shift register to NOC 107 and thus to the progressively larger level-two and level-three memories (L2 and L3) and signaling PHYs. The collective circuit block shown at 129, including an individual MAC unit 121 and the L0 memory stripe (column) and I/O register element coupled to that MAC unit, is referred to herein as a MAC processor, with the TPU including a total of L such MAC processors implementing a collective parallel MAC pipeline. In some contexts, the MAC units themselves may be referred to (or viewed as) constituting the MAC processors, with the L0 memory and/or shift-out register comprising processor-support circuitry. In any case, broadcast data register 117 outputs a sequence of shared input data values, one per MAC cycle, to all MAC processors (i.e., all MAC processors operate on the same broadcast data value during a given multiply-and-accumulate (MAC) cycle.

Still referring to FIG. 1, the various PHYs within inferencing IC 100 include a host I/O PHY 131 (e.g., compliant with a Peripheral Component Interconnect express (PCIe) standard or any other practicable standard or proprietary physical signaling hardware set/control protocol) to enable bidirectional information and/or instruction exchange with respect to a host processor or other control component; a memory-control PHY 133 to support read/write access to a system-level memory installation (e.g., dynamic random access memory (DRAM), flash memory, etc., disposed on a socketed memory module or implemented in any other practicable form factor), and one or more general-purpose I/O PHYs 135, 137 used, for example and without limitation, to coordinate operation between (gang) two or more inferencing ICs in a multi-chip inferencing system (with such multiple inferencing ICs 101 disposed in shared package to form a system-in-package, multi-package IC, three-dimensional IC, etc., or implemented as discrete components and interconnected via printed-circuit-board traces or other wired or wireless signaling media), establish network interconnect (e.g., according to any practicable Internet or intranet (WAN, LAN) physical layer interconnect and/or protocol suite), access nonvolatile storage media, etc. Various additional or alternative PHYs may be implemented within inferencing IC 101 in alternative embodiments, and any practicable higher-layer protocols may be implemented in connection with a given PHY (e.g., Compute Express Link or other memory-semantic protocol implemented over PCIe physical layer installation of host I/O PHY 131; memory control protocols according to various JEDEC standards implemented via memory control PHY 133; etc.). Also, the L3 and L2 memories disposed within (or accessed via) interconnect circuitry 103 may be implemented by various memory technologies in any combination (e.g., DRAM, static random access memory (SRAM), non-volatile memory, etc.) and, like processing-tile-resident L1 memory and TPU-resident L0 memory, are operationally distinguished by storage capacity and access speed/latency, with L0 memory nominally being the smallest, fasted on-chip memory and L3 being the largest (highest capacity), slowest on-chip memory. Additional or fewer memory levels may be implemented within the on-chip memory hierarchy in other embodiments, and the dispositions of individual memory levels may vary in all cases.

Referring again to the exemplary TPU detail view 115 (one of the sixteen TPUs disposed within processing tile 1 and coupled in common to the data output lines of the tile-resident L1 memory 109), each of the L multiply-accumulate units 121 execute parallel tensor processing operations—in effect matrix multiplication operations in which a two dimensional matrix of filter weight values (F_{KL}, where ‘K’ and ‘L’ are the matrix row and column indices) is vector-multiplied with a one dimensional input-data tensor, D_{K} to yield an output tensor Y_{L}. As discussed below, the input data tensor D_{K} generally constitutes a fragment or sub-tensor of a substantially larger input tensor (i.e., with segments of that tensor progressively loaded into processing tiles 101 via hierarchical memory levels (and thus ultimately into L0 memories of individual TPUs 107) after retrieval from external memory and/or receipt from the host or data network via the memory PHY/host PHY/GPIO PHY) and output tensor Y_{L} likewise constitutes a fragment or sub-tensor of a substantially larger output tensor. The vector multiplication operation yields, as each component value within the output tensor, a convolution of the filter matrix and input tensor—multiplication of each weighting element within a given column of the filter matrix with a respective input data element within the input tensor to produce K multiplication products which are summed to produce a respective data element within the output tensor. That is: Y_{L}=ΣF_{KL}*D_{K}, for K=0 to maxK, so that Y₀=ΣF_{K0}*D_{K}, Y₁=ΣF_{K1}*D_{K}, . . . , Y_{maxL}=ΣF_{KmaxL}*D_{K}. Accordingly, in a vector multiplication of a filter weight matrix having K*L component values (filter elements or weighting values) with an input data tensor having K data elements, each of L components of the YL output tensor is produced by performing K multiplication operations and K accumulations of the multiplication products into the tensor output value and thus K multiply-and-accumulate operations pipelined in a sequence of MAC cycles (i.e., generating multiplication product during a given MAC cycle and, during that same MAC cycle, adding product generated during previous MAC cycle into accumulated sum). While an intuitive approach to convolving multiple input data elements and filter elements is to apply all the different data elements simultaneously as operands in parallel multiplication operations (i.e., K simultaneous multiplications with the K different data values in each MAC cycle), such “multi-data” approach requires (i) shifting/rotating of the input data elements (D[K]) relative to partially accumulated output values (Y[L]) following each MAC cycle (i.e., as each of the K input data values is applied in a respective one of the K multiplication operations feeding into a given output value, Y), and (ii) that all K data elements of the input tensor be loaded into respective MAC processors prior to commencement of the initial MAC cycle—a “load phase” that requires K serial shift operations (K MAC cycles where the data load circuitry and MAC processors are timed by the same clock) or a widened input data port (e.g., K*b wide, where ‘b’ is the bit-depth of an individual input data value).

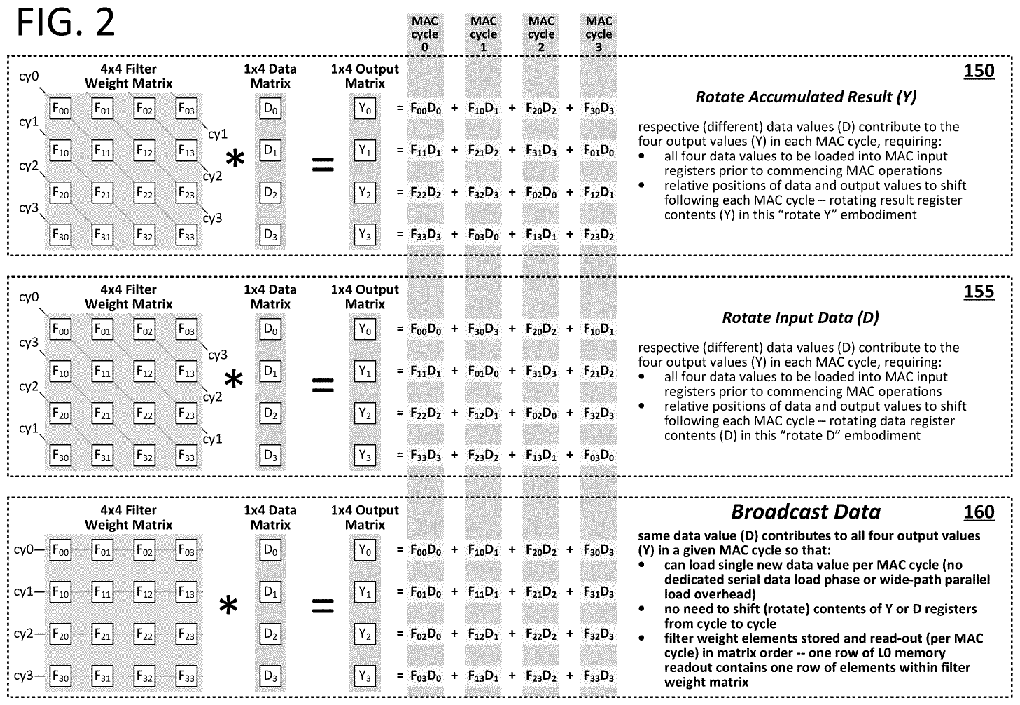

FIG. 2 contrasts the multi-data tensor processing scheme with a broadcast-data tensor processing approach implemented within the TPUs of FIG. 1, showing alternative “rotate result” and “rotate input” instances of the multi-data scheme at 150 and 155, respectively, and the broadcast-data approach at 160—all in the context of an exemplary 4×4 filter weight matrix, 1×4 input-data matrix and 1×4 result matrix (i.e., K=4, L=4). In the rotate-result (or “rotate Y”) and rotate-data examples at 150 and 155, all four of the input data values (D₀, D₁, D₂, D₃) are applied in each of four MAC cycles to yield four result values (Y₀, Y₁, Y₂, Y₃)—each of the four input data values being multiplied with a respective filter weight in each MAC cycle in accordance with the respective filter-weight selections shown by “cy0”, “cy1”, “cy2”, “cy3”. Because all input data values are loaded prior to commencement of multiply-accumulate operations and because all four input data values are applied to yield a given result value, either the input data values or accumulated results are exchanged between the MAC processors following each MAC cycle (i.e., each MAC processor receives either the input data value or the partially accumulated result value from another of the MAC processors) to enable contribution of a new one of the input data values to a given product accumulation—a data exchange implemented, for example, by circular shifting (rotating) of the data values or the partially accumulated result values among the MAC processors. In the result rotation approach at 150, the input data values are maintained within respective MAC processors throughout the vector multiply operation (no input data rotation), with partial accumulation results rotated following each MAC cycle to effect cycle-to-cycle data/result realignment. In addition to the added latency of loading all data values into the MAC processor bank before commencing multiply-accumulate operations (i.e., the multi-data load latency), result rotation tends to shrink operational timing margin as the inter-processor result exchange consumes part of the MAC cycle allocated to add the partially accumulated result and locally generated multiplication product. Moreover, the set of weighting operands applied in any given MAC cycle are drawn from a diagonal slice of the filter weight matrix (i.e., each weighting value applied in a given MAC cycle has both a unique row index and a unique column index relative to all other weighting values applied in that same MAC cycle) complicating filter matrix storage within memory—requiring either (i) matrix elements to be stored in skewed alignment within L2, L1, L0 memories so that the diagonal matrix slices (sets of filter weights aligned along diagonals within the filter weight matrix) may be read out cycle by cycle, or (ii) specialized readout architecture within the L0 memory that effects the diagonal slice (e.g., skewing the address decode to select entries from different L0 memory rows for respective MAC processors).

Still referring to FIG. 2, cycle-to-cycle input data rotation as shown at 155 avoids the timing budget strain of the result rotation scheme (i.e., no same-MAC-cycle application of neighbor-sourced value in an arithmetic operation), but suffers the same multi-data load latency and skewed filter matrix application as the result rotation approach (as the input data values are rotated while the accumulation values remain static in respective MAC processors, the cycle-to-cycle progression through the weighting matrix includes the same diagonally-aligned values in reverse order). The broadcast-data approach by contrast, avoids the multi-data load latency as the same input data value is applied within all MAC processors during a given MAC cycle so that (i) only one shared input data value (broadcast data value) must be loaded into the constituent MAC processors of a given TPU before commencing MAC operations and (ii) each of the K shared input data values may be supplied to the MAC processors in succession over the sequence of K MAC cycles required for the vector matrix multiply—just-in-time data delivery that avoids the extensive pre-load latency of the data exchange architectures (150, 155). The broadcast-data approach also avoids skewed weighting value storage/read-out as the MAC units apply respective weighting values from the same row of the filter weight matrix during each MAC cycle (progressing cycle-by-cycle through all rows of the filter weight matrix). Moreover, because there is no cycle-to-cycle data exchange between the MAC processors (all MAC processors load the same newly broadcast data value (D_{K}) in each MAC cycle), the total number of MAC cycles applied in a given vector multiplication and thus the dimension K of the filter weight matrix (F_{KL}) and input data tensor (D_{K}) is unshackled from (rendered independent of) the number of MAC processors applied in the vector multiplication (the processor count otherwise being constrained/configured to ‘K’ ensure rotation of K input-data values or K partially accumulated results among K MAC processors). Nor are MAC cycle timing budgets encumbered by data exchange latency (e.g., in contrast to the result-rotation approach in which result exchange and summation operations are executed sequentially in the same MAC cycle).

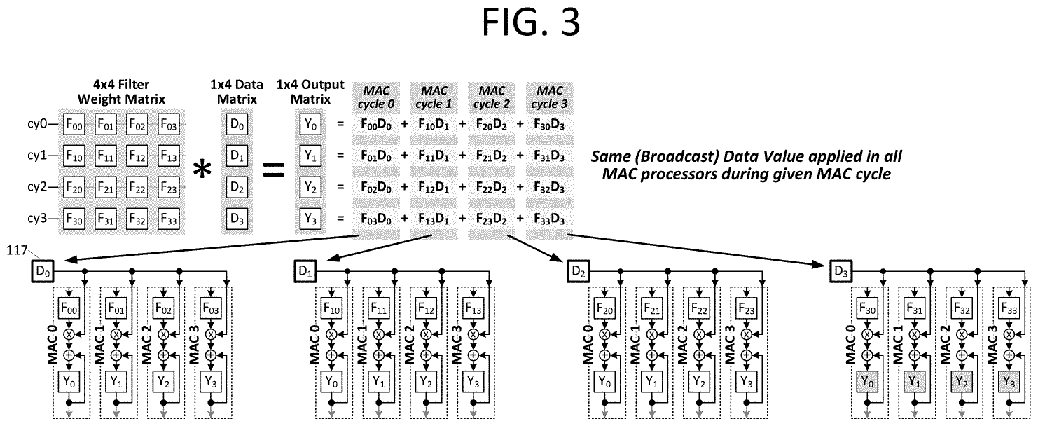

FIG. 3 illustrates an exemplary execution of the FIG. 2 broadcast data example within an exemplary set of four MAC processors (MAC0-MAC3), showing the cycle-by-cycle transition of the input data value and respective rows of the filter weight matrix applied within the MAC processors in each MAC operation. As the same input data value is supplied to (and thus shared by) all four MAC processors during each cycle, vector multiplication commences after loading the first input data value (D0) into processor-shared data register 117 (i.e., broadcast data register)—no need to load all four data values (which in practical application is generally a much higher number—64, 128, 256, 512, etc.—incurring a correspondingly higher latency). Moreover, the filter weights applied in each MAC cycle correspond to a respective row of the 4×4 filter matrix, meaning that the filter weight elements may be stored within MAC processor memory (“L0” memory and higher order memory) in matrix order and thus without the pre-skew required by the data/result-rotation schemes. Further, as there is no input data or result exchange, component values of the output tensor are generated one-for-one within respective MAC processors and without regard to the row dimension (K) of the filter weight matrix and input data matrix, and therefore independently of the number of MAC cycles (and MAC operations) executed to achieve the final output result. For example, the 4-column by 4-row (4×4) filter weight matrix and 1×4 input data matrix may be generalized to a 4×K filter weight matrix and 1×K input data matrix (K being any practicable value, for example, within the data overflow limitation of the hardware set) with each MAC processor executing K MAC cycles to generate the finalized output result (instead of the four MAC cycles shown). By contrast, in a data/result rotation scheme, component 4×4 results must generally be pre-loaded into the MAC processor accumulators (i.e., register elements Y₀-Y₃) following each 4×4 operation, iteratively executing the component 4×4 vector-multiply operation (and partial result pre-load) with respective sets of pre-loaded input values until all K input data values and K rows filter weight values have been convolved.

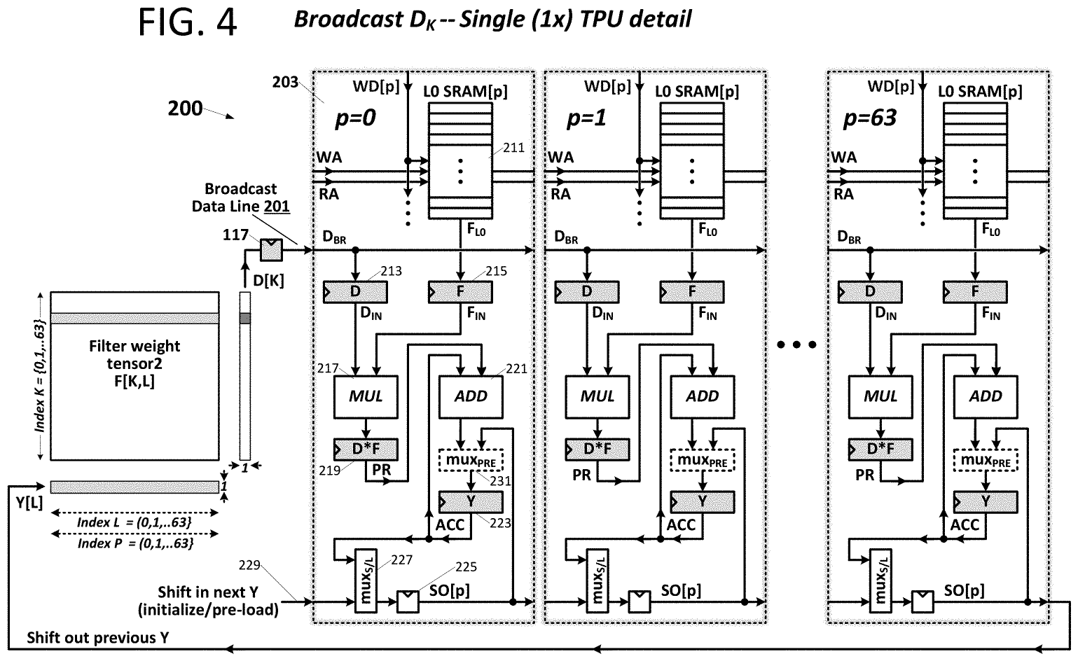

FIG. 4 illustrates a more detailed embodiment of a broadcast-data TPU 200 having a broadcast data register 117 that drives, via broadcast data line 201, a shared input data value (D[K]) to each of 64 MAC processors 203 (i.e., processor index ‘p’ ranges from 0 to 63 and, in this example, matches the number of components ‘L’ of output tensor Y_{L}). In the depicted implementation, each of the MAC processors includes an L0 SRAM stripe 211 (e.g., to store K filter weight operands to be multiplied, within a given MAC processor, with the K sequentially broadcast data values in K respective MAC cycles), a data operand register 213, weight operand register 215, multiplier circuit 217, product register 219, adder circuit 221 and accumulated-result register 223 (referred to herein as the “result” register for brevity). As shown, the L0 memory stripes (i.e., L0 SRAM[p]) within the 64 MAC processors—collectively forming the TPU L0 memory—receive a shared set of read and write address signals, RA and WA, the former (RA) to select filter weight operands (F_{L0}) output from the per-processor L0 memory stripes 211 to the weight operand registers 215 of respective MAC processors 203, and the latter (WA) to enable unloaded filter weight operands (i.e., operands already output to weight operand registers 215) to be overwritten with inbound operand values (i.e., arriving via per-processor write data lines WD[p]) to be applied in subsequent vector multiplication operations. In a number of embodiments, the collective L0 memory formed by per-processor stripes 211 (which may be implemented by register files, SRAM arrays, or any other practicable small-footprint memory) is dual ported to enable simultaneous read and write operations, with read/write control logic (e.g., implemented with TPU 200 though not specifically shown) to sequence the read and write addresses through respective modulo counts (i.e., from zero to K, and then back to zero—with the write address lagging one or more entries behind the read address) and also to output control signals as necessary to time read and write address decoding operations, etc. In other embodiments, the L0 memory may include two banks of single-ported storage elements, with one bank serving as the operand readout source during a given vector multiply interval while the other bank is loaded (during that same vector multiply interval) with filter weight operands to be applied in a subsequent vector multiply interval, the two banks switching roles at commencement of that subsequent vector multiply interval.

In the FIG. 4 embodiment, broadcast data register 117, per-processor operand registers (213, 215), per-processor product registers 219 and per-processor result registers 223 are clocked/synchronized by a shared clock signal (or respective clock-tree-generated instances of two or more same-phase clock signals) to implement pipelined data broadcast, operand load, product load, and product accumulation operations—operations executed in respective stages of a MAC pipeline with each stage of execution (“pipestage”) with regard to a given input data value transpiring in a respective clock cycle, referred to herein as a “MAC” cycle. More specifically, an input data value is clocked into the processor-shared broadcast data register 117 in a broadcast data load pipestage, and then into the data operand register 213 during an ensuing operand load pipestage (in which a corresponding weighing operand is loaded from L0 memory into weighting operand register 215). The operand load pipestage is followed by a product load pipestage in which a multiplication product generated by multiplier 217 (i.e., combinatorial logic to multiplying the operands output from registers 213 and 215) is loaded into product register 219. The product load pipestage is followed in turn by a result load pipestage—loading the output of adder 221 (i.e., combinatorial logic to add the multiplication product from product register 219 and the product accumulation (if any) previously loaded into result register 223) into result register 223, thus accumulating a sum of cyclically generated multiplication products within result register 223.

At the conclusion of a vector multiply operation, the output tensor (accumulated within collective result registers 223 of the MAC processors) is transferred from the result registers to a bank of shift-out registers 225 via shift/load multiplexer 227—one such shift-out register 225 per MAC processor 203 in the depicted embodiment—freeing the result registers 223 for a subsequent vector multiply operation. As shown, the shift-out registers 225 are coupled to one another (via ports within shift/load multiplexers 227) to form a shift register or queue such that, during respective MAC cycles of the subsequent vector multiply operation, the contents of shift-out registers 225 (i.e., output tensor) may be shifted out, tensor component by tensor component, to downstream circuitry (e.g., to shift-in input 229 of another TPU via NLINK/NOC interconnect circuitry) and/or for storage within on-chip (L2, L3) or external memory. An optional pre-load multiplexer 231 is imposed between adder 221 and result register 223 of each MAC processor to enable content shifted into the shift-out register bank to be parallel-loaded (i.e., transferred in parallel) into result registers 223, thus effecting a data pre-load (e.g., partially accumulated output tensor where a given vector multiply is split into component operations executed over respective sets of MAC sequences/cycles). Though not specifically shown, a finite state machine, sequencer or other control circuitry may be implemented within each TPU (or shared among multiple TPUs) to issue various control/configuration signals to the multiplier 217, adder 221, shift/load multiplexer 227, and pre-load multiplexer 227 within each of the MAC processors and/or other TPU components (e.g., inter-TPU adder circuitry, TPU interconnect circuitry, etc.), for example, to control multiplexer operation, enable multiplication/summation operations with various data formats (floating point, fixed point, etc. all with various precision/bit-depth, etc.), override (e.g., forcing to zero) the result-register input to adder 221 to reset the accumulated result during the first product accumulation within a vector multiply operation, and so forth.

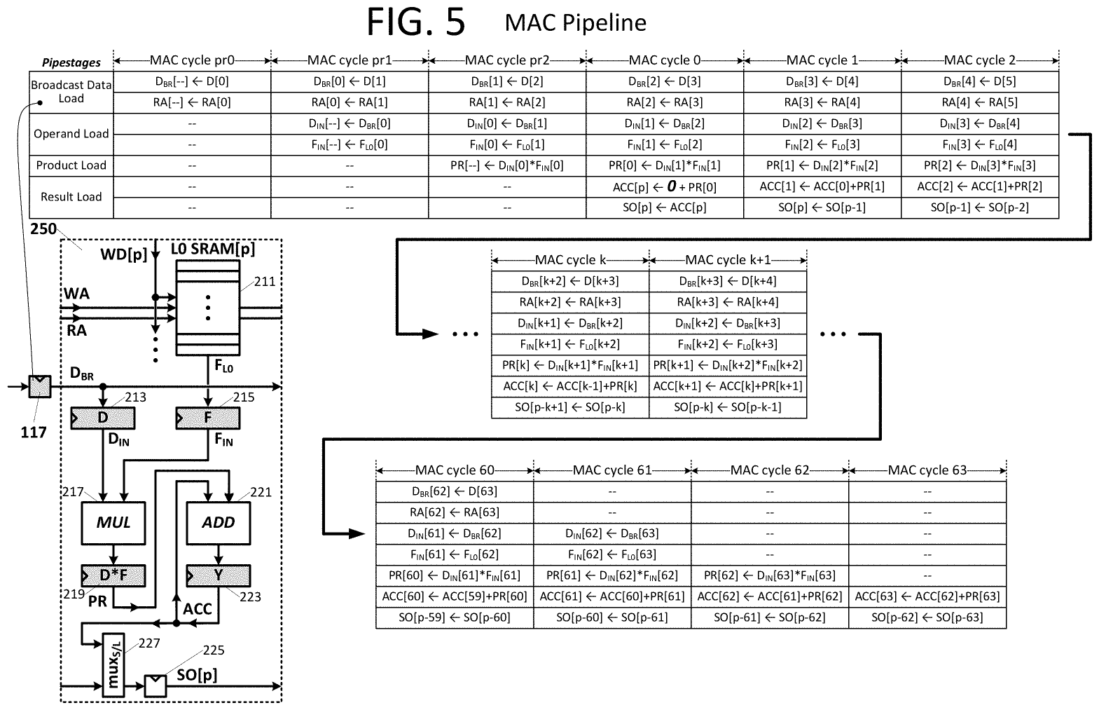

FIG. 5 illustrates an exemplary pipelined vector multiplication executed within the FIG. 4 broadcast-data TPU in the aforementioned pipestages (broadcast data load, operand load, product load, result load) over three MAC-pipeline-priming timing cycles (MAC cycles pr0, pr1 pr2) and then 64 MAC operation cycles (MAC cycles 0-63). The pipestages are executed concurrently within all MAC processors of the TPU, with a single representative MAC processor 250 shown in FIG. 5 for ease of reference (identical to the FIG. 4 MAC processors, except for omission of pre-load multiplexer 231). As shown, an initial broadcast data load is executed within the broadcast data load pipestage during priming cycle pr0 (loading the first broadcast data value, D[0], into broadcast data register 117 to become D_{BR}[0] as shown by the notation “D_{BR}[-]← D[0]”) and, during that same pipestage, the L0 read address (e.g., a pointer register) is updated to the address of the initial filter operand for the subject MAC processor (i.e., “RA[- -]←RA[0]”), thus producing initial filter weight F_{L0}[0] at the L0 memory output (F_{L0}). In the ensuing priming cycle (pr1), the broadcast data value (D_{BR}[0]) and L0 filter weight output (F_{L0}[0]) are loaded into data operand register 213 and weighting operand register 215, respectively, in an execution of the operand load pipestage (i.e., D_{IN}[- -]←D_{BR}[0] and F_{IN}[- -]←F_{L0}[0]),) while the broadcast data load pipestage is re-executed to (i) load a new input data value into broadcast data register 117 (D_{BR}[0]←D_{BR}[1]) and (ii) advance the read address (RA[0]←RA[1]) to produce a new filter weight value F_{L0}[1] at the output of L0 memory 211. In priming cycle pr2, the product load pipestage is executed to store the multiplication product of the operands from registers 213 and 215 (i.e., output of multiplier circuit 217 and thus D_{IN}[0]*F_{IN}[0], where ‘*’ denotes multiplication) into product register 219, while the broadcast data load and operand load pipestages are repeated (in the same pr2 priming cycle) to load D[2] into broadcast register 117, advance the read address to render F_{L0}[2] at the L0 memory output, and load D_{BR}[1] into data operand register 213 and F_{L0}[1] into weighting operand register 215. As the data depth of the vector multiply operation (K) is 64 in the FIG. 5 example, the first of 64 MAC cycles commences after priming cycle pr2, including execution of the result load pipestage to (i) transfer the accumulated result from any prior vector multiply operation from result registers 223 (i.e., within the collective set of MAC processors 250) to shift-out registers 225 via multiplexer 227 (“SO[p]←ACC[p],” where ‘p’ is the MAC processor index), and (ii) load the accumulator-zeroed output of adder circuit 221—that is, a sum of product register output PR[0] and a forced-to-zero accumulated-result operand (e.g., a reset of the previously accumulated sum effected by assertion of an accumulator reset signal to adder 221)—into result register 223 as indicated by the notation “ACC[p]←0+PR[0].” During that same initial MAC cycle (MAC cycle 0), broadcast data load, operand load and product load pipestages are executed to advance new operands into the broadcast data register, operand registers and product register as discussed above. Accordingly, at the conclusion of MAC cycle 0, the shift-out registers within MAC processors 250 collectively contain the output tensor generated during a prior vector multiply operation, the result registers within all MAC processors contain the initial multiplication product (i.e., PR[0] and thus the product of D_{BR}[0] and F_{L0}[0]), and the product registers, operand registers and data broadcast registers (and L0 read address) are primed to yield a sequence new multiplication products (of sequentially supplied input data and filter weight values) to be accumulated into the result registers in the 63 ensuing MAC cycles 1-63. Moreover, as the head-of-queue shift-out register 225 (e.g., register 225 within MAC processor 63 in the FIG. 4 embodiment, though MAC processor 0 may instead constitute the head of queue, with shift-out occurring in the direction reverse of that shown) outputs the head-of-queue component of output tensor generated during the prior vector multiplication operation following MAC cycle 0, shift out operations executed within the ensuing 63 MAC cycles produces the remaining 63 output tensor components of the prior vector multiplication at the head of the shift-out queue (i.e., to be transferred in succession to downstream circuitry)—an operation indicated by “SO[p−k+1]←SO[p−k]” for generalized MAC cycle k.

In the exemplary four-stage pipeline depth shown in the FIGS. 4 and 5 embodiments, the final broadcast data load pipestage for a given vector multiply operation is executed in MAC cycle K-4 (MAC cycle 60 in this K=64 example), the final operand load pipestage is executed in MAC cycle K-3 (MAC cycle 61) and the final product load pipestage is executed in MAC cycle K-2 (MAC cycle 62) as indicated by the placeholder or null-operation designation “- -” in those pipestages for MAC cycles 61-63. In a fully-loaded operational sequence in which vector multiply operations are executed back-to-back (i.e., no idle pipestages), the final three pipestages of a given vector multiply operation constitute the priming MAC cycles (pr0-pr2) for a subsequent vector multiply operation and, conversely, the initial three priming cycles of a given vector multiply operation may be committed to the final operand load, product load and result load pipestages of a prior vector multiply operation. In alternative embodiments, one or more cycles of delay may be imposed between vector multiply operations as necessary to account for memory access latency, additional tensor output processing or any other operational overhead.

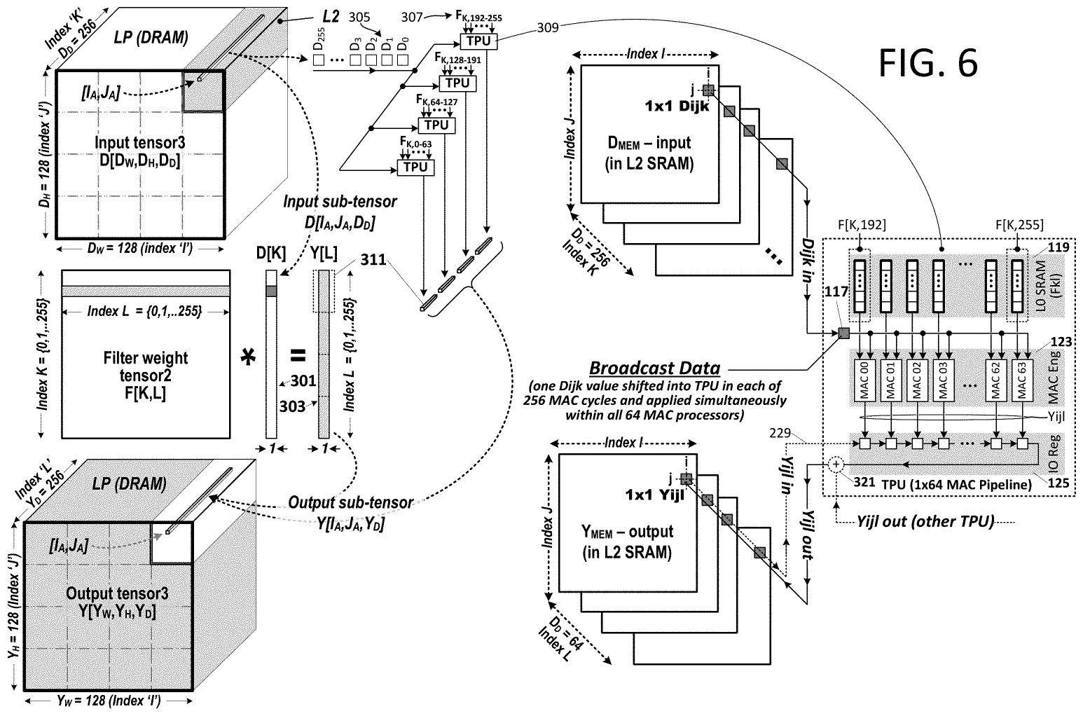

FIG. 6 presents an exemplary tensor processing operation executed via parallel component-tensor processing within the data-broadcasting TPUs of FIG. 1 in accordance with the FIG. 5 MAC pipeline (and FIG. 4/FIG. MAC processor embodiments). In the depicted example, an input data tensor3 (the ‘3’ suffix indicating a three-dimensional tensor) having a 128×128 array of input sub-tensors 301, each 256 data elements deep (K=256 such that the total number of input tensor3 data elements is 2⁷*2⁷*2⁸=2²² n-bit data elements) is convolved with a two-dimensional 256×256 filter weight matrix tensor (i.e., filter weight tensor2) to produce an output data tensor3 having a 128×128 array of 256-element output sub-tensors 303. As each broadcast-data TPU includes 64 parallel MAC processors in this instance, and each of the 256 input data values of a given input sub-tensor is to be multiplied by a respective set of 256 filter weights (i.e., a respective one of K rows of filter weight tensor2), the sub-tensor processing operation is executed in the FIG. 6 example by sequentially shifting each of the 256 input data values (constituents of input sub-tensor 301) in parallel into respective broadcast data registers of four broadcast-data TPUs as shown at 305. The L0 memories within the TPU quartet are loaded with respective column-stripes of the tensor2 filter weights such that, for example, the first of the four TPUs is loaded with the filter weights from columns 0-63 of filter weight tensor2, the second of the four TPUs is loaded with filter weights from tensor2 columns 64-127, the third TPU of the quartet is loaded filter weights from tensor2 columns 128-191, and the last of the four TPUs is loaded with filter weights from tensor2 columns 192-255 (i.e., as shown generally at 307 and in the exemplary TPU detail at 309). Accordingly, as the data input index ‘k’ advances from 0 to 255 (more generally, from 0 to K−1), the read address applied within the L0 memories of the TPU quartet (four broadcast data TPUs) allocated to process input sub-tensor 301 is likewise advanced from 0 to 255 so that each TPU of the quartet generates a respective one-fourth fragment 311 of output sub-tensor 303, with the four fragments being shifted out of the quartet TPUs in parallel for storage (as sub-tensor 303) within memory allocated for output data tensor3.

Still referring to FIG. 6, exemplary input and output data flow within each TPU of the sub-tensor processing quartet is shown in detail view 309. As shown, each of 256 input data values is loaded, MAC cycle by MAC cycle, into the broadcast data register 117 of the TPU and thus applied simultaneously within all 64 multiply-accumulate units within MAC engine 123 (each MAC unit receiving a respective sequence of 64 filter weights from L0 memory 119), yielding a quarter-fragment of the output sub-tensor after 256 MAC cycles (i.e., fragment containing 64 of 256 component values of the output sub-tensor), shifting that sub-tensor fragment out of the TPU via shift-out register (I/O register) 125 during execution of an ensuing input sub-tensor processing interval (ensuing 64-MAC-cycle interval). Note that summation circuitry 321 may be provided (e.g., within the NLINK component of a given TPU—shown for example at 127 in FIG. 1) to sum the sub-tensor output with that of another TPU, thus providing flexibility for alternative TPU groupings (and thus alternative parallel processing arrangements) within the FIG. 1 inferencing IC. The output of a given TPU (or other TPU) may also or alternatively be pre-loaded into a given TPU (e.g., via pre-load multiplexers as shown at 223 in FIG. 4) to enable a partial accumulation result to be re-applied in a subsequent MAC processing sequence. With regard to pre-loading, for example, where input data dimension K for a given sub-tensor processing exceeds practical limitations (e.g., product or accumulated-result register bit depths, L0 memory row count, etc.), sub-tensor processing may be segmented into n successive operational sub-intervals, accumulating partial results with respect to K/n input data values and K/n rows of filter weight values in each operational sub-interval. The partial results generated by a given TPU during an operational sub-interval may be stored within memory (e.g., L2 and/or L3 memory) and then later pre-loaded into the same or a different TPU via the shift-in path (e.g., as shown at 229 in FIGS. 4 and 6) to enable continued result accumulation with respect to another of the K/n input data values (and another of the K/n rows of filter weight values).

Continuing with FIG. 6 and assuming the exemplary number of broadcast-data TPUs shown in FIG. 1 inferencing IC 100 (i.e., eight tiles each including 16 broadcast-data TPUs and thus 128 broadcast-data TPUs), each of 32 TPU quartets may process a respective one of 32 input sub-tensors (generating a corresponding one of 32 output sub-tensors) per vector multiplication interval (i.e., complete MAC pipeline execution spanning 256 MAC cycles in the K=256 example of FIG. 6), thus processing each of the 16,384 input sub-tensors that constitute input data tensor3 (i.e., 128×128 sub-tensors) over 512 successive vector multiplication intervals to yield the corresponding 16,384 output sub-tensors that constitute output data tensor3. In one embodiment, each of the 256 MAC cycles within a given vector multiplication interval corresponds to the cycle time of a 16 GHz clock signal (i.e., MAC cycle time=clock cycle time, tax), so the total time required for inferencing IC 100 to convolve the four million+ (i.e., 2²²) input tensor data values with the 65 thousand+(2¹⁶) filter weight matrix is 29*28 MAC cycles/2⁴*109 MAC cycles/second=(2¹³/10⁹) seconds and thus approximately 8 microseconds. Said another way, inferencing IC 100 can perform 160,000 such tensor processing operations per second (yielding a respective output data tensor3 in each operation) and thus at a rate that enables real-time inferencing with respect to massive amounts of input data (e.g., high resolution and/or high frame rate video and possibly multiple video streams) in a single integrated circuit component—enabling IC 100 to be deployed within edge-of-network/Internet devices alone or together with other such inferencing ICs (coordinating with one another via the host PHY or via general purpose IO PHYs shown in FIG. 1) to implement real-time, in-situ inferencing.

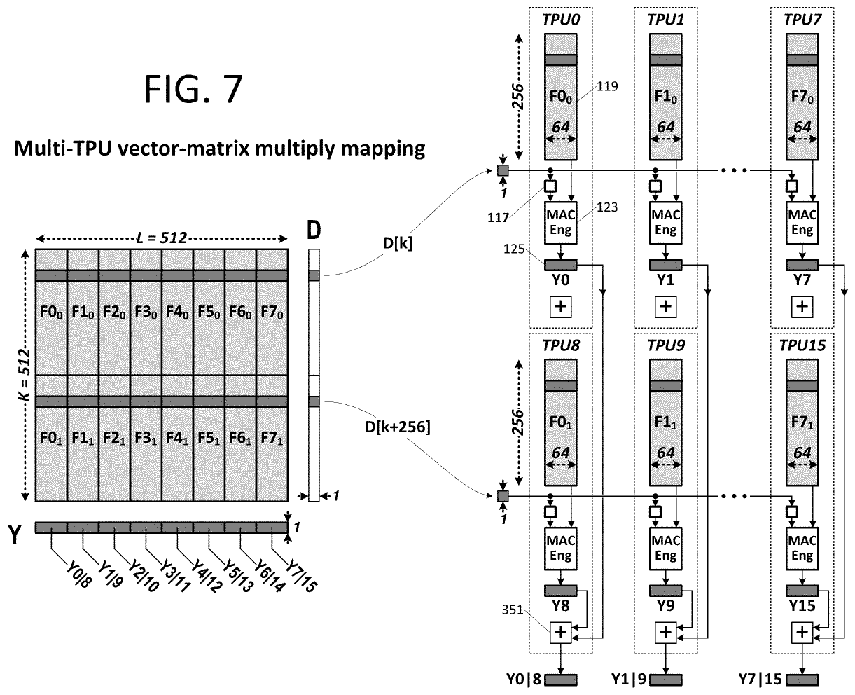

FIG. 7 illustrates an exemplary vector-matrix multiply operation parallel-processed within an array of broadcast-data TPUs. In this case, the filter weight matrix includes 512 rows and 512 columns of filter weights (2¹⁸ filter weight values) to be convolved with an input tensor having a 512-element sub-tensor data depth (i.e., K=512, L=512). In the depicted example, each of the TPUs (TPU0-TPU15) is implemented generally as shown at 115 in FIG. 1 and thus includes a data broadcast register 117 coupled in common to the data inputs of 64 MAC units (collectively forming MAC engine 123) and a 256-row L0 memory 119 in which each of 64 memory columns feeds respective weighting operand registers (e.g., as shown by column-stripes 211 and operand registers 215 in FIG. 4) within the MAC processors. As the height of the filter weight matrix (number of rows and thus dimension K) is twice the L0 memory depth (row count) and the matrix width (number of filter weight columns and thus dimension L) is 8 times the number of MAC processors per TPU (64), an array of 16 TPUs (e.g., within a single tile 101 of FIG. 1 inferencing IC 100) is allocated to parallel-process each convolution of the 512×512 filter weight matrix with a 1×256 input-data sub-tensor (D[0:255]). In the configuration shown (e.g., established by interconnect programming within the network-on-chip and/or intra-TPU NLINK circuitry 127), the array of TPUs is logically interconnected such that each of eight pairs of TPUs (TPU0/TPU8, TPU1/TPU 9, . . . , TPU7/TPU15) concurrently execute vector multiplication operations for respective halves of the input-data rows and filter-weight matrix rows and respective eighths of the filter-weight matrix columns. That is, TPUs 0 and 8 (forming TPU pair 018) execute vector multiply operations for the upper 256 rows and lower halves (upper and lower sets of 256 rows) of the filter weight matrix (F0₀ and F0₁, respectively) and input data sub-tensor (D[0-255] and D[256-511], respectively) and the first 64 columns of the filter weight matrix, while TPUs 1 and 9 (forming TPU pair 119) execute vector multiply operations for F1₀ and F1₁, respectively (i.e., the second set of 64 filter-matrix columns), with respect to the same input data, and so forth. Thus, a first shared input data value, D[k] (where k is sequenced from 0 to 255), is broadcast to all TPUs processing the upper half of the filter weight matrix and input data sub-tensor (i.e., TPUs 0-7), and a second shared input data value, D[k+256], is concurrently/simultaneously broadcast to all TPUs processing the lower half of the filter weight matrix and input data sub-tensor (i.e., TPUs 8-15). As the vector multiply result within each TPU of a given pair represents a partial accumulation of half the constituent MAC operations with respect to a given component of the output sub-tensor, those results are summed (e.g., within adder 351 disposed, for example, in the NLINK circuit (element 127 in FIG. 1) of a given one of the TPUs of each the TPU pair to produce a complete output sub-tensor value and thus, for each TPU pair, a x64 fragment of the complete (Y[0:511]) output sub-tensor. Thus, TPU pair TPUO/TPU8 generates output sub-tensor fragment Y018 =Y[0:63], TPU pair TPU1/TPU9 generates output sub-tensor fragment Y119 =Y[64:127], and so forth to TPU pair TPU7/TPU15 which generates output sub-tensor fragment Y7115 =Y[448:511]. In alternative embodiments, particularly where the L0 memory within each TPU permits low-overhead loading of successive sets of filter weight rows (e.g., dual-ported L0 memory that may be loaded with new filter weights as previously-loaded filter weights are read out and applied; or dual L0 memory banks that alternate between pre-load and read-out roles) and MAC processor register size permits, a single set of eight MAC processors may execute the vector multiplication shown in FIG. 7 (i.e., each processing a respective one of the eight columns of filter weight values, F0-F7) over 512 MAC cycles. Conversely, an additional set of 16 TPUs may be engaged in parallel with the 16 TPUs shown in FIG. 7 to halve the total vector multiplication time—for example, each of four TPUs (forming one of eight quartets) may be allocated (e.g., through run-time and/or production time configuration/interconnection) to vector-multiply a respective set of 64 rows of the filter weight matrix and input data sub-tensor to generate four partial accumulation results that are summed to yield a respective x64 fragment of the output sub-tensor (a parallelism that may be extended through allocation of yet additional sets of TPUs to further reduce vector multiplication time).

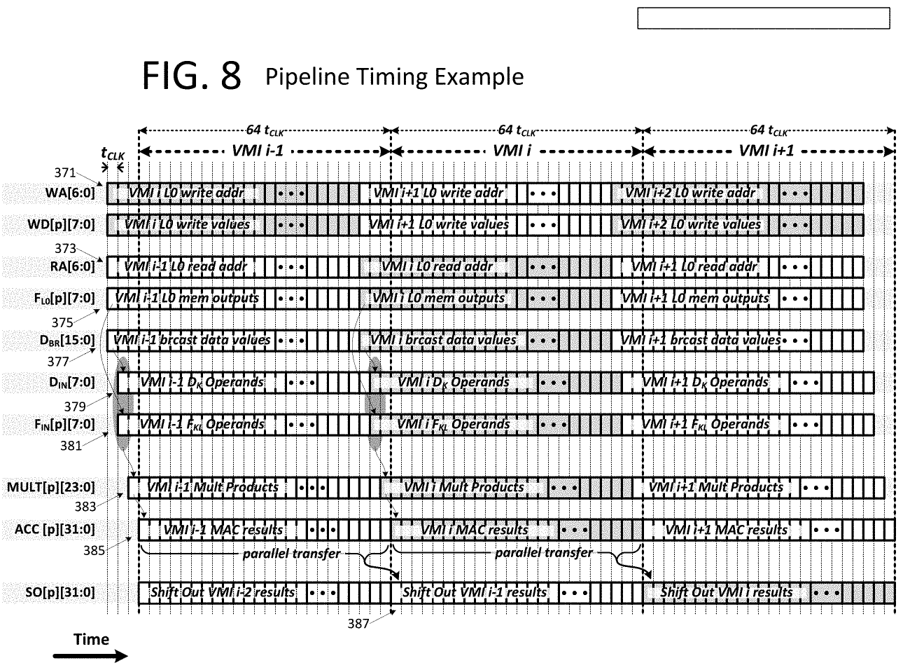

FIG. 8 illustrates an exemplary MAC pipeline timing diagram corresponding to the FIG. 5 MAC pipeline, showing a sequence of vector multiply intervals (VMI i−1, VMI i, VMI, i+1) and pipelined operations therein. As in the FIG. 5 MAC pipeline example, the three MAC cycles (each corresponding to a cycle of a pipestage clock, t_{CLK}) prior to a given vector multiply interval constitute priming cycles for an upcoming MAC operation and, when the pipeline is fully loaded, the latter three MAC cycles of a prior vector multiply interval (i.e., in which the final multiply-and-accumulate operations for a prior vector multiplication are completed). In the FIG. 8 embodiment, the L0 memory for a given TPU is loaded with filter weight values for an ensuing vector multiply interval as the L0 memory contents (filter weight values) for the current vector multiply interval are read out—for example, sequencing the write address (WA) for writing the per-MAC-processor VMI i filter weight data (WD[p][7:0]) just behind the read address sequencing (RA) for the VMI i−1 data read-out as shown at 371 and 373 (the write and read operations may be staggered in time to avoid contention if necessary, and/or the weighting data write may be executed with respect to one of two role-alternated L0 memory banks, while the weighting data read is executed with respect to the other of the two L0 memory banks as discussed above). In either case, the read address sequencing yields a sequence of per-processor L0 memory outputs F_{LO}[p][7:0] simultaneously with sequential input data load into the TPU broadcast register as shown at 375 and 377. Each of the filter weight and broadcast data values are loaded into per-processor operand registers in the ensuing MAC cycle (as operands D_{IN} and F_{IN}[p] as shown at 379 and 381), yielding multiplication products one MAC cycle later (383) and then accumulation of those products yet another MAC cycle later—in the initial cycle of a 64-cycle vector multiply operation as shown at 385. Pipelined operations directed to the i^{th} vector multiply interval (“VMI i”) are shaded in the FIG. 8 example to delineate the transitions between constituent operations of predecessor and successor vector multiply operations (VMI i−1 and VMI i+1, respectively) in the temporally staggered stages of the MAC pipeline. As in the embodiments discussed above, upon conclusion of a given vector multiply interval, the collective result register content within the TPU (i.e., within respective result registers of the constituent MAC processors of the TPU) is transferred in parallel to the shift-out register bank, and then shifted out of the TPU during the subsequent vector multiply interval—an operation shown at 387.

FIG. 8 shows, in the signal legends at left, exemplary bit-depths of the L0 read and write addresses (7-bit values corresponding to 128-row L0 memory), filter weight values, input data values, multiplication products and accumulated results. Any or all of those bit depths may be larger or smaller in other embodiments and the filter weight values, input data values, multiplication products and accumulated results may be represented in any of a variety of data formats (e.g., positive integer, signed integer, fixed point, floating point, logarithmic) with any practicable bit-depth allocation to the multiple components of a floating point, logarithmic or other compound numeric format. Also, where desirable or necessary, additional pipestages may be provided to enable data format conversion (e.g., fixed point to floating point or vice-versa) and/or matrix transformation (e.g., transforming linear matrix to Winograd or other representational format) or any other tensor processing operations.

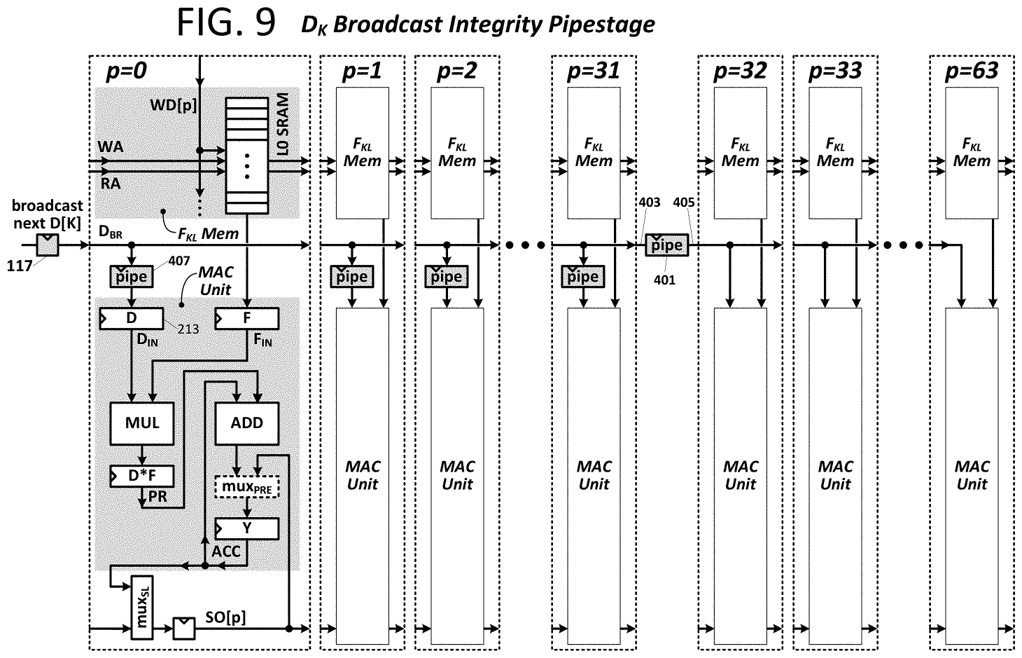

In embodiments discussed above, the broadcast data value (e.g., output from broadcast data register 117 as shown in FIGS. 1 and 4) is latched within input data registers (e.g., operand register 213 as shown in FIG. 4) of all MAC processors in response to the same clock edge (e.g., rising or falling edge of MAC clock). Accordingly, where the broadcast data register is disposed at one edge of the collective MAC processor implementation (the MAC processor “block”), each newly loaded broadcast data value must propagate from one end of the MAC processor block to the other (and thus via a relatively long and high capacitance signaling link) within a timing budget set by the MAC cycle time (tcLK) less the worst-case setup time (worst process, voltage and temperature corner) of the per-processor data operand registers—a timing budget that potentially constrains the MAC clock frequency. In a number of embodiments, this timing constraint is relaxed by physical disposition of the broadcast data register midway (or otherwise part way) through the MAC processor block, for example, between MAC processors 31 and 32 (in a TPU having 64 MAC processors numbered 0 to 63), to halve the broadcast data propagation distance and flight time. In those same embodiments, separate/distinct broadcast data lines (each conveying identical instances of the broadcast data value) may be output from the broadcast data register to two 32-MAC-processor subsets of the MAC processor block thus nominally halving the capacitance on the broadcast data line instance coupled to a given half of the MAC processors. In those and other embodiments, the broadcast data line (or any portion thereof) may also be segmented by one or more pipestage registers to increase timing margin and/or enable higher speed clocking. FIG. 9 illustrates an embodiment of a broadcast-data TPU having such register-segmented broadcast data line—in this example, a single additional pipestage register 401 disposed midway between the 64 MAC processors of the TPU (i.e., between MAC processors 31 and 32) to split the broadcast data line into upstream and downstream segments (403, 405, respectively). Because all MAC processors downstream from the broadcast-segmenting pipestage register 401 (i.e., MAC processors 32-63, coupled to downstream segment 405 of the broadcast data line) receive the broadcast data value one MAC cycle later than the upstream MAC processors (0-31), additional per-processor pipestage registers 407 are imposed between upstream broadcast data line segment 403 and data operand registers 213 of all upstream MAC processors (i.e., MAC processors 0-31) to levelize data operand registration within all MAC processors of the TPU (i.e., load the broadcast data value into data operand registers 213 of all 64 MAC processors in the same MAC cycle). In other embodiments (particularly in implementations having larger numbers of MAC processors per TPU), two or more pipestage registers may be deployed to segment the broadcast data line (into three or more segments), with additional pipestage registers implemented within upstream MAC processors (according to number of downstream pipestage registers 401) to levelized data operand loading, and corresponding number of pipestages added into the MAC processing pipelines shown in FIGS. 5 and 8 to account for the increased data load latency. In all cases, broadcast data register 117 may be disposed strategically within the MAC processor block to minimize data propagation time—for example, physically centering the broadcast data register between two branches of MAC processors, with the broadcast data line to each branch segmented by one or more pipestage registers; or physically centering the broadcast data register within four quadrant-arranged subsets of MAC processors (e.g., at the center of a two-by-two matrix of MAC processors, each quadrant of the matrix including a group of MAC processors coupled to an optionally segmented broadcast data line).

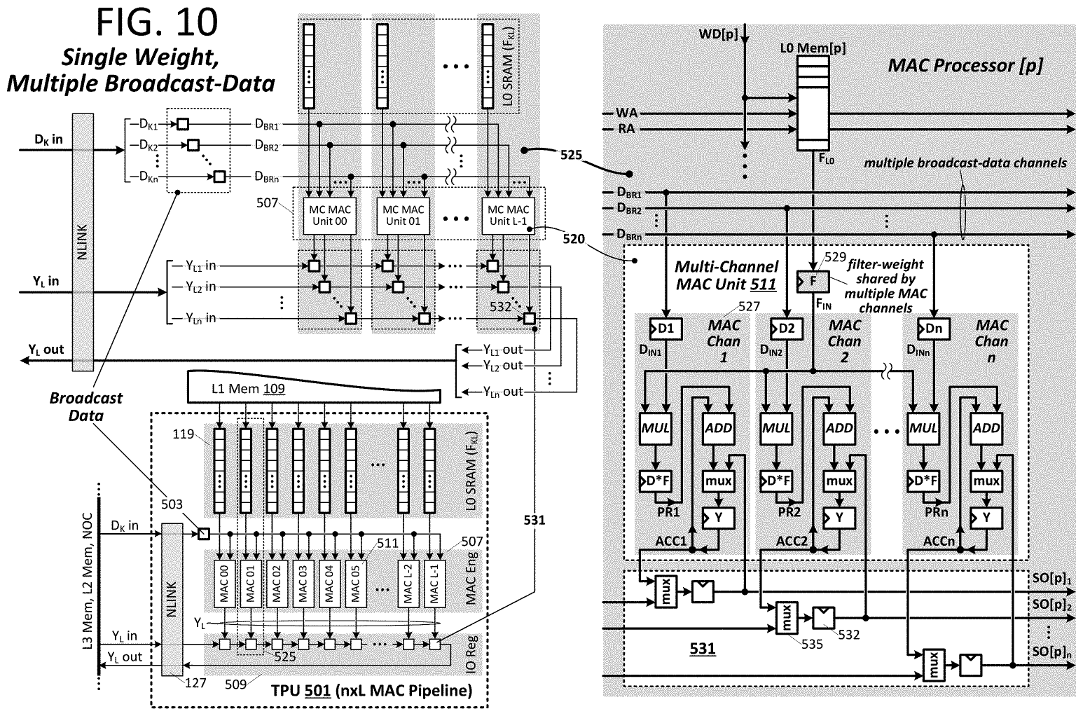

FIG. 10 illustrates an alternative embodiment of a broadcast-data TPU 501, in this case having a multi-channel broadcast data store 503, multi-channel MAC engine 507 and multi-channel data I/O structure 509 that enables two or more independent or correlated streams of broadcast data values (D_{K1}, D_{K2}, . . . , D_{Kn}) to be vector multiplied with a given filter weight matrix simultaneously (i.e., during the same vector multiply interval and thus the same set of K MAC cycles) to yield corresponding streams of output values (Y_{L1}, Y_{L2}, . . . , Y_{Ln}). Referring to exemplary detail view 520, a MAC unit 511 within each of L MAC processors 525 includes ‘n’ parallel sets of multiply-accumulate circuits 527 that implement respective multiply-accumulate channels (i.e., MAC channels 1 through n), with each of the MAC channels within a given MAC unit receiving, as operands during a given MAC cycle, a common/singular filter weight value (i.e., all MAC channels within a given MAC unit 511 receiving the same shared weight value) and a respective broadcast data value from one of the ‘n’ broadcast data streams (or broadcast data channels). By this arrangement, the MAC channels within each MAC unit 511 collectively perform multiply-and-accumulate operations with respect to a shared sequence of weighting values (a single weighting value per MAC cycle) and respective sequences of multiple broadcast data operands and thus implement a single-weight, multiple broadcast-data (SWMBD) architecture. The multi-channel I/O structure 531 within each MAC processor generates (via multiple shift-out registers 532 each sourced by a respective MAC channel within the corresponding MAC unit) a multi-channel MAC output constituted by two or more independent or correlated streams of output data values (SO[p]₁, SO[p]₂, . . . , SO[p]ₙ, where ‘p’ is the processor index and, in this example, ranges from 0 to L−1) following a given vector-multiply interval, with the MAC output streams constituting vector multiplications of the same filter weight matrix with respective input data subtensors. While shown and described herein as constituting a data I/O structure distinct from constituent MAC units 511 of MAC engine 507, the shift-out registers 532 (and path multiplexers 535) within individual MAC processors may alternatively be viewed as a component of multichannel MAC unit 511, and the entirety of the I/O register structure 509 (which also enables shift-in for pre-load as discussed above) may likewise be deemed a component of MAC engine 507. Also, the number of MAC processors 525 per broadcast data channel need not be uniform and/or individual broadcast data channels may be processed in overlapping subsets of MAC processors. For example, broadcast data channel D_{K1} (registered as D_{BR1}) may be supplied to MAC processors 0 to L−1, while broadcast data channel D_{K2} (registered as D_{BR2}) is simultaneously supplied to MAC processors 0 to M−1 (where M is an integer greater than, less than, or equal to integer L). In the overlap case, one of the broadcast data channels may be coupled to MAC processors 0 to L−1, while another is coupled to MAC processors J to K+L−1, where J is an integer between 0 and L−2, inclusively, and K is an integer greater than zero.

Still referring to FIG. 10, the individual MAC channels (or MAC circuits 527) within a given multi-channel MAC unit 511 each include multiply-and-accumulate circuitry that operates generally as discussed above (e.g., each MAC channel implemented by the registers, multiply circuitry, adder circuitry and optional multiplexers generally as discussed in reference to FIG. 4), except that filter weight register 529 (counterpart to register 215 in FIG. 4) delivers a shared/common filter weight operand to the multiplier circuits within each MAC channel (additional data and/or filter-weight registers may be provided to meet loading requirements as discussed, for example, in reference to FIG. 9) to effect single-weight, multiple broadcast data operation. Also, as discussed below, where data values on individual broadcast data channels share a logical or numeric association (e.g., respective k-bit components of a K-bit value, where K=2*k, 4*k, 8*k, etc.), the MAC channels may include and be coupled to one another via linking or inter-coupling circuitry (e.g., to share carry data, convey data fragments for operation with counterpart channel, etc.).

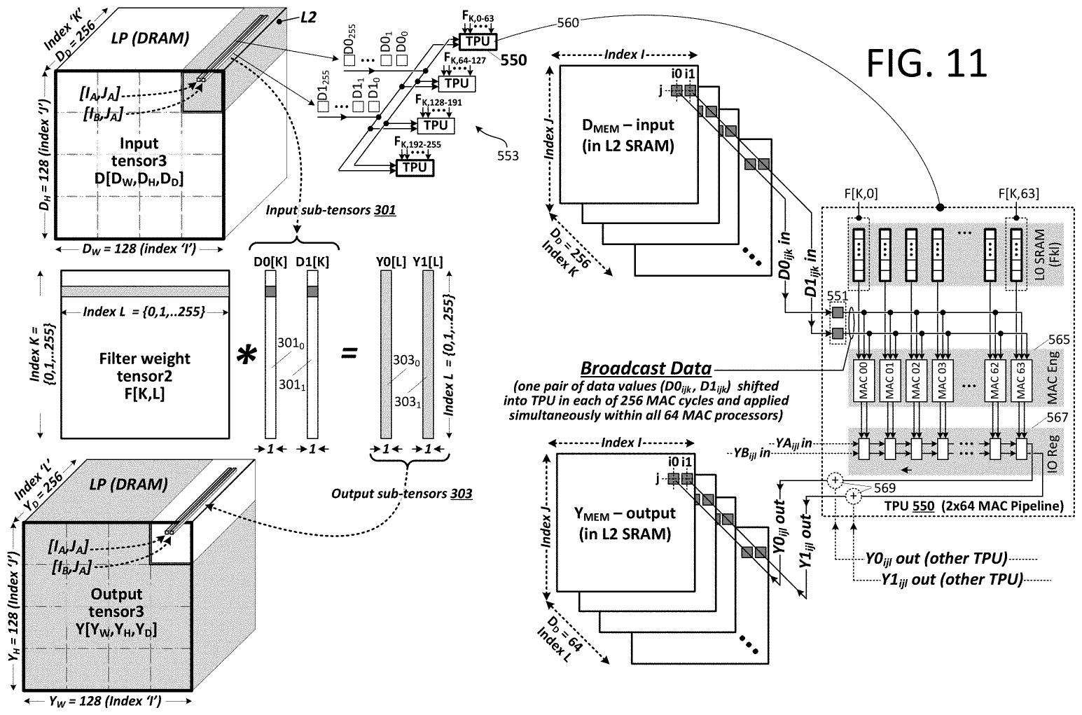

FIG. 11 presents an exemplary tensor processing operation executed via parallel component-tensor processing within a single-weight, multiple broadcast data TPU 550 implemented generally as shown FIG. 10 but in this instance more specifically having two broadcast data channels. As in the FIG. 6 example, an input data tensor3 having a 128×128 array of sub-tensors 301, each 256 data elements deep (K=256 such that the total number of input tensor3 data elements is 2⁷*2⁷*2⁸=2²² n-bit data elements) is convolved with a two-dimensional 256×256 filter weight matrix tensor (i.e., filter weight tensor2) to produce an output data tensor3 having a 128×128 array of 256-element output sub-tensors 303. As each broadcast-data TPU includes 64 parallel multi-channel MAC processors—two broadcast data channels per MAC processor in this instance—and each of the 256 input data values of a given input sub-tensor is to be multiplied by a respective set of 256 filter weights (i.e., a respective one of K rows of filter weight tensor2), two simultaneous sub-tensor processing operations are executed in the FIG. 11 example by sequentially shifting two streams of 256 input data values (i.e., D0₀-D0₂₅₅ constituting input sub-tensor 301₀ and D1₀-D1₂₅₅ constituting input sub-tensor 301₁) in parallel into a given TPU 550, and more specifically, shifting four copies of the D0 and D1 data streams in parallel into respective broadcast data register pairs (e.g., as shown at 551 in TPU detail view 560) within each of four dual-channel broadcast-data TPUs 550 (“TPU quartet”) as shown at 553. The L0 memories within the TPU quartet are loaded with respective column-stripes of the tensor2 filter weights such that, for example, the first of the four TPUs 550 is loaded with the filter weights from columns 0-63 of filter weight tensor2, the second of the four TPUs is loaded with filter weights from tensor2 columns 64-127, the third TPU of the quartet is loaded filter weights from tensor2 columns 128-191, and the last of the four TPUs is loaded with filter weights from tensor2 columns 192-255. Accordingly, as the data input index ‘k’ advances from 0 to 255 (more generally, from 0 to K−1), the read address applied within the L0 memories of the TPU quartet (i.e., four dual-broadcast-data-channel TPUs) allocated to process input sub-tensors 301₀ and 301₁ is likewise advanced from 0 to 255 so that each TPU of the quartet generates a respective one-fourth fragment of output sub-tensor 303₀ and a respective one-fourth fragment of output sub-tensor 303₁ (i.e., as generally shown above in FIG. 6 with respect to a single input data channel implementation), with the four fragments of each of the two output sub-tensors 303₀ and 303₁ (eight fragments in all) being shifted out of the quartet TPUs in parallel for storage within memory allocated for output data tensor3.

Still referring to FIG. 11, exemplary input and output data flow within each TPU 550 of the sub-tensor processing quartet is illustrated in detail view 560. As shown, two streams of 256 input data values (D0 and D1) are loaded, MAC cycle by MAC cycle, into respective broadcast data registers (shown collectively at 551) of the TPU and thus applied simultaneously within all 64 dual-channel multiply-accumulate units of MAC engine 565 (each MAC unit receiving a respective sequence of 256 filter weights from L0 memory 119 together with the dual D0/D1 broadcast data sequences), yielding a quarter-fragment of output sub-tensor 303₀ and a quarter-fragment of output sub-tensor 303₁ after 256 MAC cycles (i.e., each fragment containing 64 of 256 component values of a respective one of output sub-tensors 303₀ and 303₁), shifting those two sub-tensor fragments out of the TPU via dual-channel shift-out register (I/O register) 567 during execution of an ensuing dual-sub-tensor processing interval (ensuing 256-MAC-cycle interval). As shown, summation circuitry 569 may be provided (e.g., within the NLINK component of a given TPU—shown for example at 127 in FIG. 1) to sum the dual sub-tensor outputs with corresponding dual-channel outputs of another TPU, thus providing flexibility for alternative TPU groupings (and thus alternative parallel processing arrangements) within the host inferencing IC. The dual-channel output of a given TPU (or other TPU) may also or alternatively be pre-loaded into a given TPU (e.g., via pre-load multiplexers as shown at 535 in FIG. 10) to enable a partial dual-channel accumulation result to be re-applied in a subsequent MAC processing sequence. With regard to pre-loading, for example, where input data dimension K for a given sub-tensor pair processing exceeds practical limitations (e.g., product or accumulated-result register bit depths, L0 memory row count, etc.), sub-tensor processing may be segmented into n successive operational sub-intervals, accumulating partial results with respect dual K/n input data channels and K/n rows of filter weight values in each operational sub-interval. The partial results generated by a given TPU during an operational sub-interval may be stored within memory (e.g., L2 and/or L3 memory) and then later pre-loaded into the same or a different TPU via the dual-channel shift-in path (e.g., as shown by the YAᵢⱼₗin, YBᵢⱼₗin paths in FIG. 11) to enable continued result accumulation with respect to another pair of the K/n input data channels (and another of the K/n rows of filter weight values). While FIG. 11 specifically illustrates two (dual) broadcast data channel processing, any practicable number of parallel broadcast data channels may be simultaneously processed (i.e., multiplied by the shared two-dimensional filter weight matrix) by an n-channel MAC unit implementation (e.g., as shown generally in FIG. 10).

Continuing with FIG. 11 and assuming an exemplary number of dual-channel broadcast-data TPUs in accordance with the architecture shown in FIG. 1 inferencing IC 100 (i.e., eight tiles each including 16 dual-broadcast-data-channel TPUs and thus 128 dual-broadcast-data-channel TPUs), each of 32 TPU quartets may process a respective one of 32 input sub-tensor pairs (generating a corresponding one of 32 output sub-tensor pairs) per vector multiplication interval (i.e., complete MAC pipeline execution spanning 256 MAC cycles in the K=256 example of FIG. 11). Thus, the 32 TPU quartets may processing each of the 8,192 input sub-tensor pairs that constitute input data tensor3 (i.e., 128×128 sub-tensors) over 128 successive vector multiplication intervals to yield the corresponding 8,192 output sub-tensor pairs that constitute output data tensor3. In one embodiment, each of the 256 MAC cycles within a given vector multiplication interval corresponds to the cycle time of a 16 GHz clock signal (i.e., MAC cycle time=clock cycle time, tcLK), so the total time required for a dual-channel SWMBD implementation of inferencing IC 100 to convolve the four million+(i.e., 2²²) input tensor data values with the 65 thousand+(2¹⁶) filter weight matrix values is 2⁹*2⁷ MAC cycles/(2⁴*10⁹ MAC cycles/second)=(2¹²/10⁹) seconds and thus approximately 4 microseconds. An inferencing IC that implements 128 quad-broadcast-data channel TPUs (i.e., same number of TPUs as in FIG. 1, but four broadcast data channels per TPU) halves that processing time to approximately 2 μS and an eight-broadcast-data-channel architecture (8 broadcast data channels per TPU) halves that processing time again to ˜1 μS and so forth.

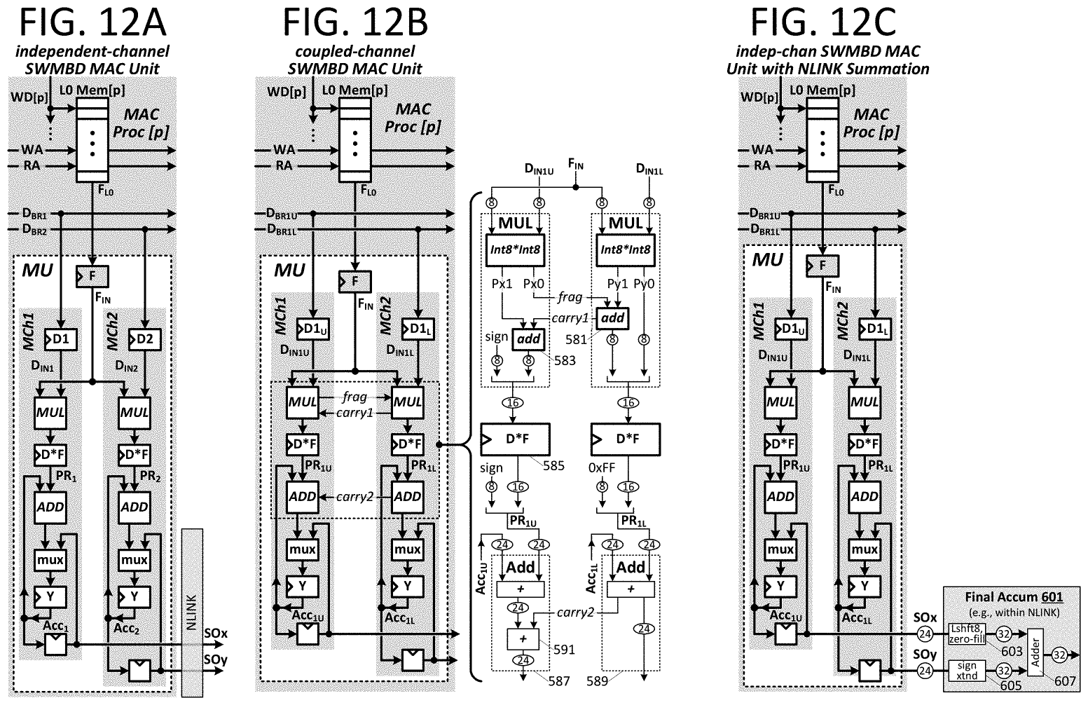

FIGS. 12A, 12B and 12C illustrate contrasting embodiments of dual-channel MAC units that may be implemented (or programmably configured/enabled) within the various SWMBD TPU embodiments discussed above. In the FIG. 12A embodiment, dual MAC channels (MCh1, MCh2)—each including the registers, multipliers, and multiplexers discussed above in reference to FIG. 10 (and not all of which are shown)—generate and shift-out independent multiply-accumulate results generally as discussed above, with those independent results being output from the TPU (SOx, SOy) via NLINK circuitry as shown. In FIG. 12B, by contrast, the dual MAC channels are functionally inter-coupled to exchange information in accordance with a correlation between the two incoming broadcast data values. In the depicted example, the two broadcast data values supplied to the dual MAC channels in a given MAC cycle constitute respective components of higher and lower significance within a collective numeric value and, more specifically in this instance, respective 8-bit components—upper byte and lower byte—of a 16-bit signed integer value. Thus, MAC channel 1 executes a signed-integer multiply of the upper broadcast data byte and a byte-sized filter weight value, while MAC channel 2 simultaneously integer-multiplies the lower broadcast data byte with that same filter weight. Each multiply operation yields a 16 bit product with respective 8-bit fragments (Px1 and Px0 for MCh1; Py1 and Py0 for MCh2), with the less-significant eight-bit fragment (or subfield) of the MCh1 product (Px0) and more-significant eight-bit fragment of the MCh2 product (Py1) having equal significance in the overall product and thus being added (i.e., lower MCh1 fragment Px0 “frag” crossing between the MAC channels to adder component 581 of the MCh2 multiplier) together to generate (i) a finalized most significant fragment of the MCh2 multiplication product, and (ii) a possible carry into the significance of the more significant fragment of the MCh1 product. Accordingly, the carry generated by adder component—“carryl” — crosses back from MCh2 to MCh1 to be added to the Px1 component of the MCh1 multiply (i.e., within adder 583) and with a sign extended pre-set value being output as the upper fragment of the final 16-bit product stored within register 585 (e.g., PR_{1U} in signed 16-bit integer format, INT16). The two INT16 multiplication products are further sign-extended at the inputs to adder circuits 587 and 589 (e.g., into respective 24-bit two's complement integer values—INT24) and then accumulated within two INT24 implementations of respective output (‘Y’) registers (i.e., iteratively summed with Acc_{1U} and Acc_{1L}, respectively, over a sequence of MAC cycles). As shown, any “carry2” resulting from the summation within adder 589 (accumulating the less significant of the two INT24 components of the final accumulation result) is conveyed from MCh2 to MCh1 to be combined with the result of adder circuit 587 (e.g., within carry-adder 591).

FIG. 12C illustrates an alternative dual-channel MAC unit embodiment in which correlated broadcast data values are processed independently within two MAC channels (i.e., MCh1, MCh2 implemented as shown in FIG. 12A) followed by post-MAC combination of the correlated results (e.g., pair of INT24 values in this example) within a final-accumulator circuit 601 (e.g., implemented within above-described NLINK circuitry or elsewhere within or outside the host TPU). In the depicted example, the most significant accumulated result (SOx) is left shifted by eight bits (603) to produce a 32-bit operand (with zero-filled least significant byte) having a one-byte higher significance than that of the less significant accumulated result (SOy). The less-significant accumulated result is sign-extended to a 32-bit operand (605) that is added to the left-shifted more significant 32-bit operand within adder 607 to yield a combined (singular) 32-bit accumulation result.

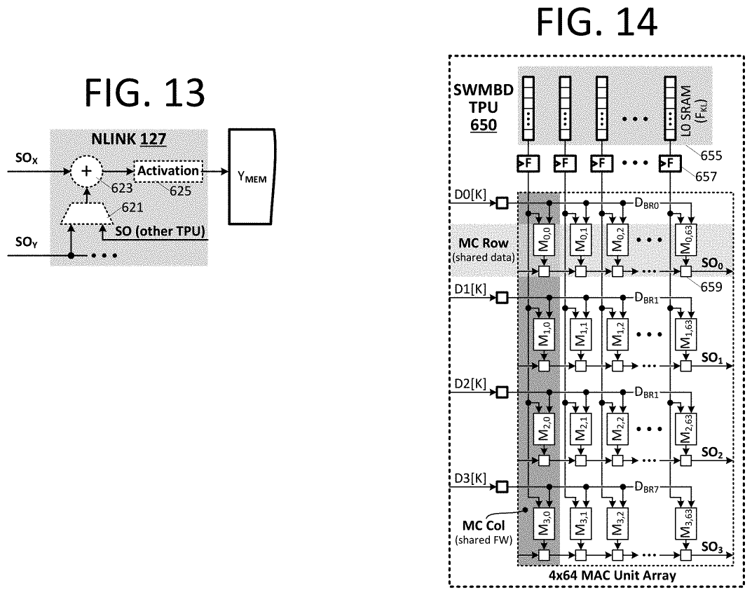

Still referring to FIGS. 12A-12C, specific data formats, precisions, bit-depths, numbers of broadcast data channels, etc. are presented for purposes of understanding and example only. In all cases, different data formats (signed or unsigned integer, fixed-point, floating point, logarithmic, etc.) with any practicable precision/bit-depth may be processed within the multi-channel MAC units shown, including multiple different data formats and/or precisions with circuitry implemented within and/or at ingress/egress points of the MAC units/MAC channels as necessary to perform such conversions. Broadcast data and filter weight operands in logarithmic data formats (i.e., values represent logarithmic values and thus exponents) may be summed and then converted to a non-logarithmic format (e.g., fixed point, floating point) to effect multiplication of corresponding non-logarithmic operands. Also, as discussed in reference to FIGS. 12B and 12C and below in reference to FIG. 13, various additional circuitry may be provided to effect multiply-accumulate operations with respect to correlated broadcast data channels either within SWMBD MAC units themselves (e.g., exchanging fragment/carry data between two or more MAC channels as shown in FIG. 12B) and/or within post-processor arithmetic circuitry (e.g., final accumulation value generated/activated within NLINKS circuitry as shown in FIGS. 12B, 12C, 13).

FIG. 13 illustrates a more generalized channel combination circuit that may be implemented within NLINK circuitry 127 (or elsewhere) of a given TPU. As shown, an optional multiplexer 621 enables the accumulated output of one of the dual channels to be summed (623) with either the accumulated output of the counterpart channel or the shift-output of another TPU. Though not specifically shown, a second adder circuit may be provided to sum the dual-channel summation (i.e., SOx+SOy, with one operand shifted in significance relative to the other as discussed in reference to FIG. 13) with a counterpart dual-channel summation from another TPU (i.e., the shift-output from the other TPU is summed with the SOx and SOy summation). In any case, the final summation result may be applied to an activation circuit 625 to yield an activated output data stream (e.g., zeroing out content below an activation threshold or otherwise effecting an activation range or function with regard to a given result) to be stored within L2 or L3 memory. In the case of independent output data channels (i.e., from a SWMBD TPU as discussed above), each shifted output may be supplied (after optional summation with outputs of another TPU) to respective instances of activation circuit 625 to deliver a parallel set of activated output streams to the output tensor memory. While dual output channels (SOx, SOy) are shown in FIG. 13 (and in FIGS. 12A, 12B and 12C), any practicable number of output channels (generated by a corresponding number of MAC channels per MAC unit) may be combined with one another and/or outputs of other TPUs in alternative embodiments.

FIG. 14 illustrates an embodiment of a SWMBD TPU 650 having 256 multiply-accumulate circuits organized in a 4-row by 64-column array, with each MAC circuit (“MR,c” where a‘R’ and ‘C’ are respective row and column positions of the MAC circuit within the array) implemented generally as shown at 527 in FIG. 10. As shown, each column of the MAC circuits (“MC Col”) is coupled to receive, as operands during a given MAC cycle, a single shared filter weight (the shared filter weight having been loaded from a respective one of 64 columns of L0 memory 655 into column operand register 657 in the preceding MAC cycle) and a respective one of four broadcast data values (D0[K]-D3[K]) and thus constitutes one of 64 four-channel MAC units. Conversely, each row of the MAC circuits is coupled to receive, as operands during the MAC cycle, a respective one of 64 filter weights (from respective columns of L0 memory) and a single shared broadcast data value. Individual shift-out registers 659 within a 4×64 register array are coupled respectively to the outputs of individual MAC circuits within the array (such shift-out registers may be deemed an element within the corresponding MAC circuit) and daisy-chained to one-another within a given MAC circuit row to form four shift-register circuits into which MAC results may be loaded following a given vector multiply interval and then shifted out to downstream circuitry during the ensuing vector multiply interval (e.g., SO₀-SO₃ shifted out via the TPU NLINK circuitry for storage within L2 or L3 memory; delivered to summation circuitry and/or shifted into shift-register circuits within the same or another TPU, etc.). Two or more MAC circuits within a given column for which respective broadcast data streams bear correlation (e.g., as discussed in reference to FIG. 12B) may exchange operational data (e.g., fragment, carry data as shown in FIG. 12B) and/or deliver respective shift-out data streams to final accumulation circuitry and/or other operational circuitry within per-TPU NLINK circuit block or elsewhere within the host TPU. As in the embodiments discussed above, data may be delivered, operated upon within the MAC circuit array and output in any practicable data formats (floating point, fixed point, logarithmic, etc.) and data precisions.

Referring to FIGS. 1-14 generally, the exemplary inferencing IC architectures, hierarchical components thereof, physical signaling interfaces, numbers of tensor processing units, TPU implementations, numbers of MAC processors per TPU, number of broadcast data channels, MAC processor implementation, memory type, amount and disposition etc. may vary in numerous details and in particular with regard to any specific numbers, dimensions, formats, time-intervals presented (quantities of tiles, quantities of TPUs, quantities MAC processors, quantities of broadcast data channels, quantities of MAC channels, bit depths, memory sizes, data formats, data precisions, matrix/array dimensions, tensor dimensions, sub-tensor dimensions, clock periods or frequencies, MAC cycles per vector multiply interval, etc.). Moreover, the various inferencing IC embodiments (and component circuits thereof) presented herein may be implemented within a standalone integrated circuit component or IC package, or within one or more IC components (including packages having multiple IC dies) that combines the inferencing and/or vector-multiply functionality thereof with one or more other functions (e.g., integrated-circuit processor, application-specific integrated circuit (ASIC), etc.). One or more programmed microcontrollers and/or dedicated hardware circuits (e.g., finite state machines, registered or combinational circuits, etc.) may implement and/or control all or part of the various architectural and functional circuit blocks within the inferencing ICs presented herein. Additionally, any or all of those architectural/functional elements (or circuit blocks) may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, computer storage media in various forms (e.g., optical, magnetic or semiconductor storage media).

When received within a computer system via one or more computer-readable media, such data and/or instruction-based expressions of the above described circuits and circuitry can be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image can thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the disclosed embodiments. In some instances, the terminology and symbols may imply specific details not required to practice those embodiments. For example, the various functional-element quantities (tiles, TPUs per tile, MAC processors per TPU, etc.), bit depths, memory sizes, tensor/matrix/sub-tensor dimensions, clock frequencies, data formats (including input data, filter weights and output data), and so forth are provided for purposes of example only—any practicable alternatives may be implemented in all cases. Similarly, physical signaling interfaces (PHYs) having any practicable link parameters, protocols and configurations may be implemented in accordance with any practicable open or proprietary standard and any version of such standard. Links or other interconnection between integrated circuit devices and/or internal circuit elements or blocks may be shown as buses or as single signal lines. Each of the buses can alternatively be a single signal line, and each of the single signal lines can alternatively be a bus. Signals and signaling links, however shown or described, can be single-ended or differential. Logic signals shown or described as having active-high assertion or “true” states, may have opposite assertion states in alternative implementations. A signal driving circuit is said to “output” a signal to a signal receiving circuit when the signal driving circuit asserts (or de-asserts, if explicitly stated or indicated by context) the signal on a signal line coupled between the signal driving and signal receiving circuits. The term “coupled” is used herein to express a direct connection as well as a connection through one or more intervening circuits or structures. Integrated circuit device or register “programming” can include, for example and without limitation, loading a control value into a configuration register or other storage circuit within the integrated circuit device in response to a host instruction (and thus controlling an operational aspect of the device and/or establishing a device configuration) or through a one-time programming operation (e.g., blowing fuses within a configuration circuit during device production), and/or connecting one or more selected pins or other contact structures of the device to reference voltage lines (also referred to as strapping) to establish a particular device configuration or operational aspect of the device. The terms “exemplary” and “embodiment” are used to express an example, not a preference or requirement. Also, the terms “may” and “can” are used interchangeably to denote optional (permissible) subject matter. The absence of either term should not be construed as meaning that a given feature or technique is required.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

What is claimed is:

1. An integrated circuit device comprising:
a plurality of broadcast data paths;
a weighting-value memory; and
a plurality of multiply-accumulate (MAC) units coupled in common to each of the broadcast data paths and coupled to receive respective weighting values from the weighting-value memory via respective weighting-value paths, each of the MAC units having a plurality of MAC circuits coupled respectively to the broadcast data paths, each of the MAC circuits within a given one of the MAC units having:
a data input coupled to receive, during each of a plurality of timing cycles, an input data value via a respective one of the broadcast data paths;
a weighting-value input coupled to receive, during each of the plurality of timing cycles, a shared one of the weighting values via a shared one of the respective weighting-value paths;
a multiplier circuit to generate a sequence of multiplication products by multiplying the input data value received during each of the plurality of timing cycles with the shared one of the weighting values received during each of the plurality of timing cycles; and
an accumulator circuit to accumulate a sum of constituent multiplication products within the sequence of multiplication products.

2. The integrated circuit device of claim 1 wherein each of the MAC circuits further comprises a data operand register, coupled between the data input and the multiplier circuit, to store the input data value received during each of the plurality of timing cycles and to output the data input value received during each of the plurality of timing cycles to the multiplier circuit.

3. The integrated circuit device of claim 1 wherein the given one of the MAC units comprises a weighting-value register to store a respective one of the weighting values received via a respective one of the weighting-value paths.

4. The integrated circuit device of claim 3 wherein the weighting-value input of each of the MAC circuits within the given one of the MAC units is coupled in common to the weighting-value register to receive, as the shared one of the weighting values, the respective one of the weighting values stored within the weighting-value register.

5. The integrated circuit device of claim 1 wherein the multiplier circuit within at least one of the MAC circuits within the given one of the MAC units is coupled to output a carry value to the multiplier circuit of at least one other of the MAC circuits within the given one of the MAC units.

6. The integrated circuit device of claim 1 further comprising a plurality of shift registers coupled in common to the MAC units, each of the shift registers being coupled to an output of the accumulator circuit within a respective one of the MAC circuits within each of the MAC units.

7. The integrated circuit device of claim 6 wherein the plurality of shift registers consists of a quantity of shift registers that matches quantity of broadcast data paths constituted by the plurality of broadcast data paths.

8. The integrated circuit device of claim 1 wherein each of the MAC circuits within each of the plurality of MAC units implements an operational pipeline in which the input data value and the shared one of the weighting values are:
received within a given one of the MAC circuits during a first timing cycle of the plurality of timing cycles;
multiplied to generate a multiplication product within the sequence of multiplication products during a second timing cycle of the plurality of timing cycles; and
accumulated into the sum of constituent multiplication products during a third timing cycle of the plurality of timing cycles, wherein the first, second and third timing cycles transpire sequentially.

9. The integrated circuit device of claim 1 wherein the plurality of MAC units each having a plurality of MAC circuits constitute a collective array of MAC circuits in which each column of the MAC circuits within the array constitutes a respective one of the MAC units.

10. The integrated circuit device of claim 9 wherein:
the plurality of MAC units comprises respective weighting-value registers to store the respective weighting values received from the weighting-value memory;
each row of the MAC circuits within the array is coupled in common to a respective one of the broadcast data paths;
each of the columns of the MAC circuits is coupled in common, via the shared one of the respective weighting-value paths, to an output of a respective one of the weighting-value registers.

11. A method of operation with an integrated-circuit (IC) device having a plurality of broadcast data paths, a weighting-value memory, and a plurality of multiply-accumulate (MAC) units coupled in common to each of the broadcast data paths and coupled to receive respective weighting values from the weighting-value memory via respective weighting-value paths, each of the MAC units having a plurality of MAC circuits coupled respectively to the broadcast data paths, the method comprising execution of the following operations in parallel within each of the MAC circuits of a given one of the MAC units:
receiving, during each of a plurality of timing cycles, an input data value via a respective one of the broadcast data paths;
receiving, during each of the plurality of timing cycles, a shared one of the weighting values via a shared one of the respective weighting-value paths;
multiplying the input data value received during each of the plurality of timing cycles with the shared one of the weighting values received during each of the plurality of timing cycles to generate a sequence of multiplication products; and
accumulating a sum of constituent multiplication products within the sequence of multiplication products.

12. The method of claim 11 further comprising storing the input data value received via the respective one of the broadcast data paths the during each of the plurality of timing cycles within a respective data operand register within each of the MAC circuits of the given one of the MAC units.

13. The method of claim 11 further comprising storing a respective one of the weighting values received via a respective one of the weighting-value paths within a weighting-value register included in the given one of the MAC units.

14. The method of claim 13 wherein a weighting-value input of each of the MAC circuits within the given one of the MAC units is coupled in common to the weighting-value register to receive, as the shared one of the weighting values, the respective one of the weighting values stored within the weighting-value register.

15. The method of claim 11 wherein multiplying the input data value with the shared one of the weighting values comprises generating a carry value within a first one of the MAC circuits of the given one of the MAC units, the method further comprising receiving the carry value within a second one of the MAC circuits of the given one of the MAC units.

16. The method of claim 11 further comprising outputting the sum of constituent multiplication products from each of the MAC circuits within the given one of the MAC units to a respective one of a plurality of shift registers.

17. The method of claim 16 wherein the plurality of shift registers consists of a quantity of shift registers that matches quantity of broadcast data paths constituted by the plurality of broadcast data paths.

18. The method of claim 11 wherein multiplying the input data value received during each of the timing cycles with the shared one of the weighting data values comprises multiplying the input data value with the shared one of the weighting data values during a timing cycle that transpires after reception of the input data value and shared one of the weighting values.

19. The method of claim 11 wherein the plurality of MAC units each having a plurality of MAC circuits constitute a collective array of MAC circuits in which each column of the MAC circuits within the array constitutes a respective one of the MAC units.

20. An integrated circuit component comprising:
a plurality of broadcast data paths;
a weighting-value memory; and
a plurality of multiply-accumulate (MAC) units coupled in common to each of the broadcast data paths and coupled to receive respective weighting values from the weighting-value memory via respective weighting-value paths, each of the MAC units having a plurality of MAC circuits coupled respectively to the broadcast data paths, each of the MAC circuits within a given one of the MAC units having:
means for receiving, during each of a plurality of timing cycles, (i) an input data value via a respective one of the broadcast data paths, and (ii) a shared one of the weighting values via a shared one of the respective weighting-value paths;
means for generating a sequence of multiplication products by multiplying the input data value received during each of the plurality of timing cycles with the shared one of the weighting values received during each of the plurality of timing cycles; and
means for accumulating a sum of constituent multiplication products within the sequence of multiplication products.
